(19) United States
(12) Patent Application Publication
(10) Pub. No.: US 2007/0001114 A1
(43) Pub. Date: Jan. 4, 2007

(54) Apparatus and method for ion capture and production

(76) Inventors: Paul C. Goodley, Cupertino, CA (US); Jean-Luc Truche, Los Altos, CA (US); Jerry T. Dowell, Carson City, NV (US); Timothy Herbert Joyce, Mountain View, CA (US)

Correspondence Address: AGILENT TECHNOLOGIES INC., INTELLECTUAL PROPERTY ADMINISTRATION, M/S DU404, P.O. BOX 7599, LOVELAND, CO, 80537-0599, US

(21) Appl. No.: 11/172,217

(22) Filed: Jun. 29, 2005

(51) Int. Cl. H01J 49/10

(52) U.S. Cl. 250/288

(57) ABSTRACT

The present invention relates to an apparatus and method for producing ions. The apparatus may be used separately as an ion source or in combination with a mass spectrometry system. The ion source of the present invention provides an ionization device for producing ions, a substrate for capturing, storing and releasing ions produced by the ionization device, a conductive material in contact with the substrate for receiving an electrical pulse, and a voltage source electrically connected to the conductive material for applying an electrical pulse to the conductive material and substrate to release the ions captured by the substrate. Also disclosed is a method for storing and releasing ions using the disclosed apparatus.

### BACKGROUND

Mass spectrometry systems determine the molecular weight of chemical compounds by separating molecular ions according to their mass-to-charge ratio (m/z). Ions are generated by inducing either a loss or gain of charge and are then detected. These systems generally comprise an ionization source for producing ions (i.e. electrospray ionization (EI), atmospheric photoionization (APPI), atmospheric chemical ionization (APCI), chemical ionization (CI), fast atom bombardment, matrix assisted laser desorption ionization (MALDI) etc.), a mass filter or analyzer (i.e. quadrupole, magnetic sector, time-of-flight, ion trap etc.) for separating and analyzing ions, and an ion detector such as an electron multiplier or scintillation counter for detecting and characterizing ions.

Various ionization sources have been developed for producing ions. For instance, (ultraviolet) UV or VUV may be used to produce ions in atmospheric photoionization. This technique utilizes an ultraviolet light that applies energy to analyte molecules to split them to produce ions. Certain chemical molecules may also be employed to produce ions in chemical ionization. Lastly, various matrixes may be used in conjunction with analyte to produce ions in MALDI and AP-MALDI. Other types of ionization devices and ways of making or producing ions are well known in the art. Ionization sources continue to develop and improve. More recently, research has begun focusing on new methods, techniques and designs for producing and controlling ions. For instance, most of the ionization devices produce ions that are collected downstream. The problem with such a method is that these techniques are not completely efficient in producing ions. In addition, once the ions are produced it can be difficult to control or direct them. Often times many ions are produced and lost in the production and collection process. In addition, based on the present design of ionization devices it is difficult to effectively ionize using a combination of ionization devices. For instance, various ionization devices have been used in tandem to improve overall ion production. This technique allows for the ionization of molecules that may not be easily converted to ions using only one ionization technique. For instance, multimode ionization sources have been developed using both electropray and APPI or APCI or other similar type combinations. The problem with this technique is that it is limited to only a linear arrangement of ionization devices to produce ions. In other words, you can only ionize according to how the instrument is designed and set-up. Molecules must first be electrosprayed and then subject to APPI or APCI. This severely impacts the overall efficiency of the ion production. In addition, there are limited devices or techniques for capturing or trapping ions and then discharging or delivering them to desired places or devices.

It, therefore, would be desirable to alleviate these problems by providing a device or mass analyzer that solves all these problems. These and other problems presented have been obviated by the present invention.

### SUMMARY OF THE INVENTION

The present invention relates to an apparatus and method for ion capture, storage and release. The present invention provides an ion source, comprising an ionization device for producing ions; a substrate for capturing, storing and releasing ions produced by the ionization device, a conductive material in contact with the substrate for receiving an electrical pulse; and a voltage source electrically connected to the conductive material for applying an electrical pulse to the conductive material and substrate, to release the ions captured by the substrate.

The invention also provides a mass spectrometry system. The mass spectrometry system, comprises an ion source, comprising an ionization device for producing ions; a substrate for capturing and releasing ions produced by the ionization device; a conductive material in contact with the substrate for receiving an electrical pulse; a voltage source electrically connected to the conductive material for applying an electrical pulse to the conductive material and substrate to release the ions captured by the substrate; and a detector down stream from the ion source for detecting ions.

The invention also provides a method for producing ions. The method comprises releasing the captured and stored ions from the substrate using a voltage source or similar type device.

### BRIEF DESCRIPTION OF THE FIGURES

The invention is described in detail below with reference to the following figures:

FIG. 1 shows a general block diagram of a mass spectrometry system.

FIG. 2 shows a perspective view of the present invention.

FIG. 3 shows a cross-sectional view of the present invention.

FIG. 4 shows an exploded view of a portion of the present invention.

FIG. 5 shows a first embodiment of the present invention.

FIG. 6 shows a second embodiment of the present invention.

FIG. 7 shows a third embodiment of the present invention.

FIG. 8 shows a fourth embodiment of the present invention.

FIG. 9 shows a fifth embodiment of the present invention.

### DETAILED DESCRIPTION OF THE INVENTION

Before describing the invention in detail, it must be noted that, as used in this specification and the appended claims, the singular forms “a,” “an,” and “the” include plural referents unless the context clearly dictates otherwise. Thus, for example, reference to “a substrate” includes more than one “substrate”. Reference to an “ionization device” includes more than one “ionization device”. In describing and claiming the present invention, the following terminology will be used in accordance with the definitions set out below.

The term “adjacent” means contacting, spaced from, containing a portion of, near, next to or adjoining. Something adjacent may be in contact with another component, may be spaced from the other component, may contain a portion of the other component, may be near another component, may be next to or adjoining the other component. For instance, an ionization device that is adjacent to an inlet, may contact an inlet, may be spaced from an inlet, may contain a portion of an inlet, may be near an inlet, may be next to or adjoining an inlet.

The term “ion source” or “source” refers to any source that produces analyte ions.

The term “ionization device” refers to any device used for producing analyte ions.

The term “detector” refers to any device, apparatus, machine, component, or system that can detect an ion. Detectors may or may not include hardware and software. In a mass spectrometer the common detector includes and/or is coupled to a mass analyzer.

The term “substrate” refers to a material that may comprise various materials for capturing, storing and producing ions. A substrate may comprise a rigid composition with a dielectric material attached or layered on it. It also may comprise the dielectric material or a portion of it may comprise the dielectric material.

The invention is described with reference to the figures. The figures are not to scale, and in particular, certain dimensions may be exaggerated for clarity of presentation.

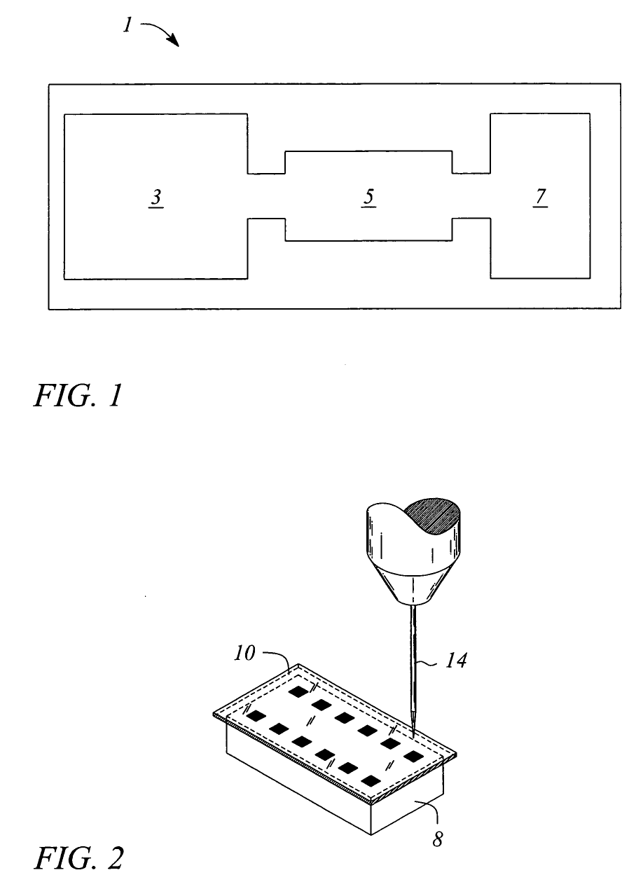

FIG. 1 shows a general block diagram of a mass spectrometry system. The block diagram is not to scale and is drawn in a general format because the present invention may be used with a variety of different types of mass spectrometry systems. A mass spectrometry system 1 of the present invention comprises an ion source 3, an ionization device 4 (not shown in FIG. 1), a mass analyzer 5 and a detector 7.

The mass spectrometry system 1 may be designed and configured in a number of ways. The ion source 3 may comprise an APPI ion source, an APCI ion source, a nanospray ion source, an electrospray ion source, a chemical ion source, a MALDI ion source, an AP-MALDI ion source, or a multimode ion source. Other ion sources well known in the art may also be employed for producing ions. Any number of different ion sources may be employed for producing ions. It is important to the invention that the ion source be capable of producing ions that may be captured or stored. The ion source 3 may be positioned in any number of directions, positions or locations relative to the ionization device 4. The ion source 3 can be positioned adjacent to the ionization device 4.

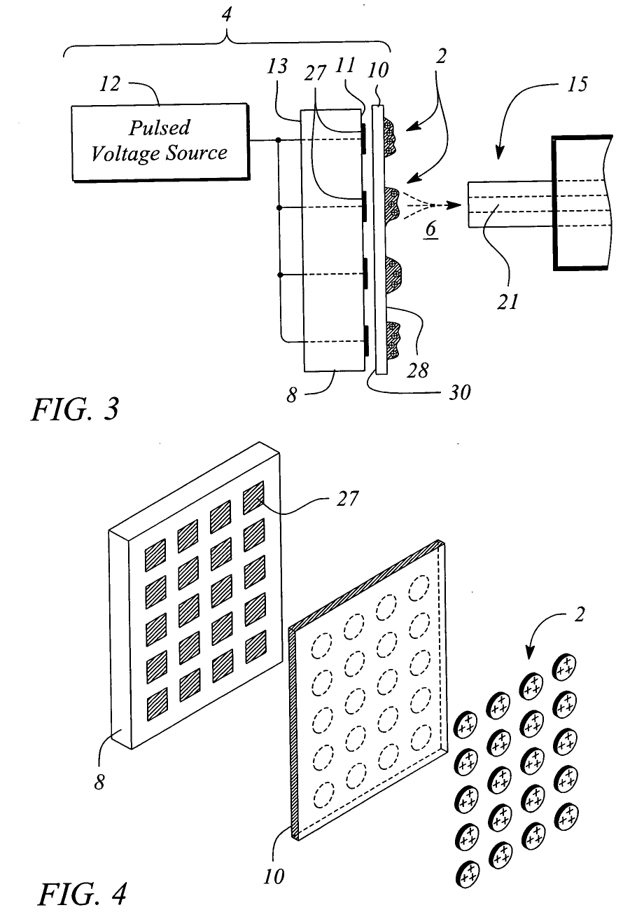

Referring now to FIG. 2-6, the ionization device 4 is important to the present invention. The ionization device 4 comprises a substrate 8 and a voltage source 12. The voltage source 12 is in electrical communication with the substrate 8. Substrate 8 may comprise a dielectric material 10. The dielectric material 10 may also be a separate component as shown in FIGS. 3 and 4. The substrate 8 may also comprise a first substrate surface 11 and a second substrate surface 13. Substrate 8 may further comprise an electrically conductive material. The electrically conductive material may comprise an electrode or similar type device. It also may comprise a material that can conduct or transport charge or electrons. The electrically conductive material may be placed on one or more surfaces of the substrate 8 or may comprise a portion of the substrate 8. FIGS. 2-4 show the electrically conductive material on a first substrate surface 11 of the substrate 8. The dielectric material 10 contacts the first substrate surface 11 of the substrate 8. The dielectric material 10 contacts the substrate 8 or substrate surface 11 in such a way that an electrical pulse may be provided to dielectric material 10 by the voltage source 12.

The detector 7 is generally positioned downstream from the ion source 3 and the mass analyzer 5 (See FIG. 1). The location of the detector 7 can vary with respect to the mass analyzer 5 and may not be on axis, but rather located on the side of the mass analyzer 5. The detector 7 may comprise any number of detectors known in the art. For instance, the detector 7 may comprise any device capable of generating an output signal indicative of the analyte being studied. Detectors may include and not be limited to devices that generate secondary electrons which are amplified or which induce a current generated by a moving charge. Some of these types of detectors include, but are not limited to an electron multiplier or scintillation counter.

The ionization device 4 is shown in more detail in FIGS. 3-4. FIG. 4 shows an exploded view of the ionization device 4. As discussed above, the ionization device 4 comprises a substrate 8, and a voltage source 12. Additional details regarding each of these components will now be provided. Dielectric material 10 may comprise a portion of the substrate 8 or in certain instances may comprises a separate component.

The substrate 8 may comprise any number of conductive and non-conductive materials. The substrate 8 may comprise a semiconductor material, a plastic type material, a resin, a thermoplastic polymer, a polymer or any other similar type materials. The material should be capable of holding or comprising a conductive material and may maintain a rigid state or structure. An electrically conductive material may comprise a portion of the substrate 8 or may be deposited on the substrate 8. In certain embodiments of the invention the conductive material may comprise one or more electrodes or electrode leads. In certain embodiments, the electrically conductive material may be positioned across the first surface 11 of the substrate 8. This is not a requirement of the invention. However, it is important to the invention that the electrically conductive material contacts the dielectric material 10. This allows an electric pulse to be carried to the dielectric material 10 from the voltage source 12.

The dielectric material comprises a first dielectric material surface 28 and a second dielectric material surface 30. The first dielectric material surface 28 contacts and captures the ions to form a sample spot 2. The second dielectric material surface 30 contacts the first substrate surface 11 or a conductive lead 27 which comprise a portion of the substrate 8. The dielectric material 10 may comprise any number of materials known in the art for capturing ions. For instance, the dielectric material 10 may comprise a polymeric material. It is important to the invention that the material be capable of capturing, storing or holding ions upon surface contact. Ideally, the material would be designed in such a way that ions in the local vicinity of the material may easily attach themselves to the material upon contact. This would not disrupt or change the charge, composition or ions themselves. Certain materials have been tested and determined to provide such properties. For instance, Captan or Mylar® materials have been particularly effective in accomplishing such tasks (For more information See Miller, S. A., et al., Science Vol. 275, 7, March 1997, entitled “Soft-Landing of Polyatomic Ions at Fluorinated Self Assembled Monolayer Surfaces”; Zoltan, T., et al., Science Vol. 306, 15 Oct. 2004, entitled “Mass Spectrometry Sampling Under Ambient Conditions with Desorption of Electrospray Ionization”; Blake, T. A., Anal. Chem. 2004, 76, 6293-6305, Preparative Linear Ion Trap Mass Spectrometer for Separation and Collection of Purified Proteins and Peptides in Arrays Using Ion Soft Landing”. All these references are herein incorporated by reference. The material must also be designed in such a way that once an electric charge or pulse is applied to the second substrate surface 13 (the opposing surface to first substrate surface 11 of substrate 8) or to the substrate 8 or its conductive material or conductive leads 27, the ions are released from the first dielectric surface 28 of the dielectric material 10 into the ionization region 6. The first dielectric surface 28 of the dielectric material 10 must be capable of capturing, storing and releasing ions under various conditions. As discussed above, the dielectric material 10 may also be designed to hold positive ions, negative ions or both. This will be dependent on the overall type of material that is employed.

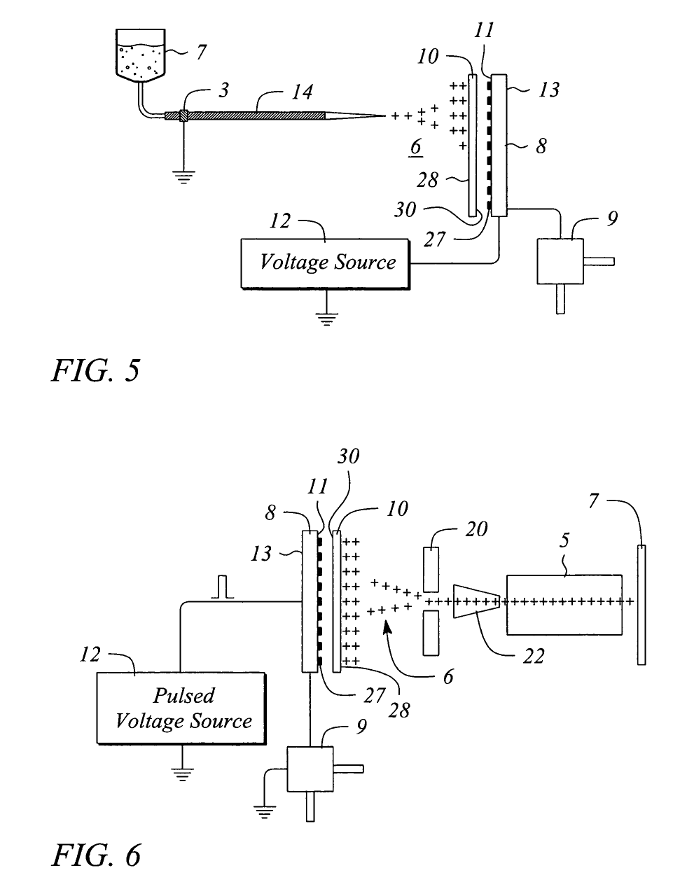

FIG. 5 shows an embodiment of the present invention. In particular, FIG. 5 shows the present invention used as a capture device for capturing and storing ions produced by an ion source 3. The ion source 3 further comprises an emitter needle 14 that may be secured using a device such as an adjustment device 9 etc. The emitter needle 14 is in fluid communication with a sample reservoir 7. The emitter needle 14 is used for producing ions or charged particles that are emitted or discharged into the ionization region 6. The substrate 8 with conductive material or electrodes may be adjusted relative to the emitter needle 14 using an adjustment device 9. Other adjustment devices known in the art may be employed with the present invention.

FIG. 6 shows a second embodiment of the present invention. In this embodiment of the invention the ionization device 4 is employed to release captured ions to a defined location. In this embodiment a pulser may be employed in electrical connection or combination with the voltage source 12. An ion optic lens 20 may be employed adjacent to an ion optics guide 22. Both the ion optic lens 20 and the ion optics guide 22 are employed upstream of the mass analyzer 5 and the detector 7. The detector 7 is shown in the drawing downstream from the mass analyzer 5, ion optics guide 22 and ion optics lens 20. Other options in place of the detector 7 may include the ionization devices 4 or dielectric capture materials as discussed above.

Having discussed the apparatus of the invention in some detail a description of the method and operation of the invention is now in order.

FIGS. 4-6 show the method of the present invention. The method of the invention can be used for storing, capturing, and transferring ions from location to another, from one place to another. Based on the capture technique the ions can be stored for a period of time and then move without subsequent loss of ions or instrument sensitivity. The method of the present invention is used for producing ions. The method comprises creating ions using an ionization device 4, storing the ions on a substrate 8, and releasing the stored ions into a defined ionization region 6.

FIG. 5 most clearly illustrates the capture and storage functions of the present invention. The ionization device 4 initially produces ions that are released into the ionization region 6 by way of the ion emitter needle 14. The ions then may contact the first dielectric surface 28 of the dielectric material 8. After contacting the first dielectric surface 8 of the substrate 8 the ions may become immobilized. This may be accomplished by use of an electromagnetic field, electric field, or electrostatic field. These fields may be created by voltage source 12. In addition, the dielectric material 8 may be design to capture ions based on the surface chemistry of composition of the material. Some effective materials are described above. However, other known materials in the art may also be employed. Ideally the material should be capable of allowing for the attachments of ions to the surface without any effect on their charge or chemistry. In addition, the material must also be capable of storing the ions for a period of time and then releasing them upon the initiation of some time of pulse, current or mechanically, In this case ions may be captured and stored for an extended amount of time without effects on their charge or composition.

FIG. 6 shows a second embodiment of the present invention and method. After the ions have been captured and stored on substrate 8, they may be released. This may be done immediately or after being transferred to a new position or location. For instance, FIG. 6 shows how the ions may be released. Ideally, FIGS. 5 and 6 can be interpreted as being separate embodiments or different stages in the capture, storage, processing and release of the captured ions. In other embodiments it can be imagined that they may be employed to work together to capture and produce ions for staged analysis. For instance, when the substrate 8 is moved into a desired position, location or orientation the ions may be released as desired. Ions are typically released from the substrate 8 by application of a pulse by voltage source 12. The voltage source 12 applies a pulse to the ionization device 4 that causes the release of the ions. In particular, the pulse is applied to the leads 27 or second substrate surface 13 of the substrate 8 of the ionization device 4. This causes the release of the ions that have been captured and stored on the surface. As shown in FIG. 6 the device can be moved or positioned to release the ions into a mass analyzer 5. In this embodiment of the invention it may be beneficial to employ an ion optics lens 20 or ion optics guide 22 for directing and guiding ions into the mass analyzer 5. A detector or other device may then be employed for analysis.

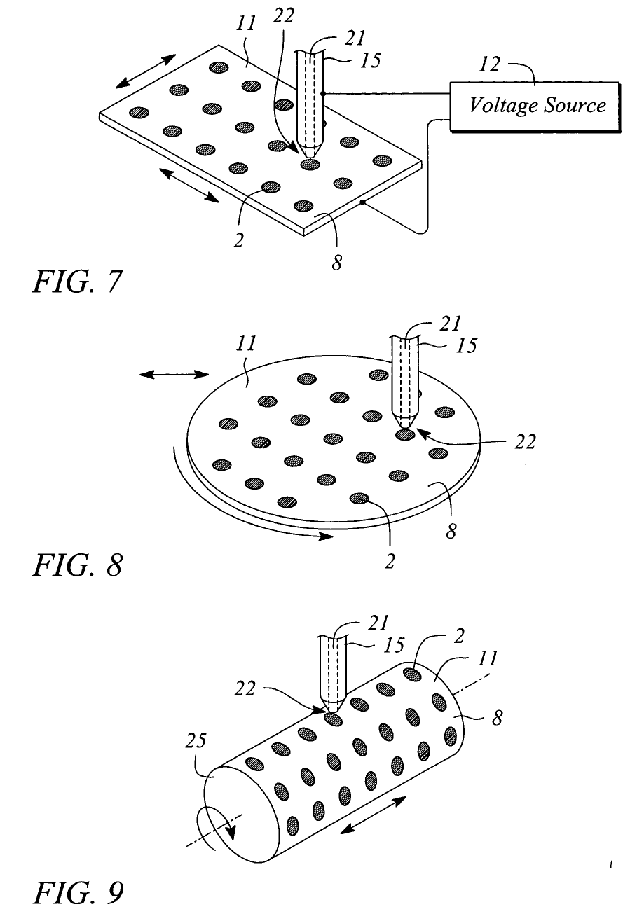

FIGS. 7-9 show additional embodiments and methods of the present invention. For instance, FIG. 7 shows the substrate 8 with sample spots 2 on the first surface 11. The sample spots have been previously collected and stored on the substrate 8. A collecting capillary 15 may then be employed to collect the ions. The ions may be pulsed off of the first surface 11 by use of the voltage source 12. The voltage source 12 may be connected to the substrate 8 directly or by using various conductive leads 27. The voltage source 12 provides a pulse to the substrate 8 to release the ions. Either the collecting capillary 15 or the substrate 8 may move while the other component is held stationary. In addition, in certain instances both the capillary 15 and the substrate 8 may be moved to provide alignment of the capillary 15 and capillary inlet 22 relative to the sample spot 2. Once the voltage source 12 provides a pulse to the substrate 8, the sample spot releases the captured ions into the capillary inlet 22.

FIG. 8 shows another embodiment of the present invention. In this embodiment of the invention the substrate 8 may be in the form of a rotating disc. The embodiment may operate similar to the design described above. However, in this situation the substrate 8 may be designed to rotate. In certain instances, the sample spot 2 may be pulsed to release ions into the capillary inlet 22. They may then be captured on a second surface 13 or be transported to a detector 7.

FIG. 9 shows a similar embodiment to FIGS. 7 and 8. In this embodiment of the invention the substrate 8 may comprise or be attached to a rotating drum 25. The rotating drum may comprise various sample spots 2. The rotating drum 25 rotates relative to the capillary inlet 22 and may be pulsed to release various ions at defined time intervals.

It is to be understood that while the invention has been described in conjunction with the specific embodiments thereof, that the foregoing description as well as the examples that follow are intended to illustrate and not limit the scope of the invention. Other aspects, advantages and modifications within the scope of the invention will be apparent to those skilled in the art to which the invention pertains.

All patents, patent applications, and publications infra and supra mentioned herein are hereby incorporated by reference in their entireties.

We claim:

1. An ion source, comprising:
(a) an ionization device for producing ions;
(b) a substrate for capturing and releasing ions produced by the ionization device;
(c) a conductive material in contact with the substrate for receiving an electrical pulse; and
(d) a voltage source electrically connected to the conductive material for applying an electrical pulse to the conductive material and substrate to release the ions captured by the substrate.

2. An ion source as recited in claim 1, wherein the substrate comprises a material selected from the group consisting of a plastic, a polymer material, a wax paper, a polyimide polymer, a PEEK polymer, a PAEK polymer, a polysulfone polymer, and a polystyrene polymer.

3. An ion source as recited in claim 1, wherein the conductive material comprises, a material selected from the group consisting of a transition metal, an alkaline earth metal, an alkali metal and an alloy.

4. An ion source as recited in claim 3, wherein the conductive material comprises a transition metal selected from the group consisting of iron, cobalt, nickel, copper, cadmium, silver, gold, platinum, lead, gallium, titantium, indium, magnesium, tin, vanadium and zinc

5. An ion source as recited in claim 1, wherein the ionization device is selected from the group consisting of an electrospray ionization device, an atmospheric pressure photoionization device (APPI), a atmospheric chemical ionization device (APCI), a multimode ionization device, a chemical ionization device, a matrix assisted laser desorption ionization device (MALDI) and an atmospheric matrix assisted laser desorption ionization device (AP-MALDI).

6. An ion source as recited in claim 1, wherein the substrate is selected from the group consisting of a plate, a rotating drum and a rotating plate.

7. A mass spectrometry system, comprising:
(a) an ion source, comprising:
(i) an ionization device for producing ions;
(ii) a substrate for capturing and releasing ions produced by the ionization device;
(iii) a conductive material in contact with the substrate for receiving an electrical pulse; and
(iv) a voltage source electrically connected to the conductive material for applying an electrical pulse to the conductive material and substrate to release the ions captured by the substrate; and
(b) a detector down stream from the ion source for detecting ions.

8. An ion source as recited in claim 7, wherein the substrate comprises a material selected from the group consisting of a plastic, a polymer material, a wax paper, a polyimide polymer, a PEEK polymer, a PAEK polymer, a polysulfone polymer, and a polystyrene polymer.

9. An ion source as recited in claim 7, wherein the conductive material comprises, a material selected from the group consisting of a transition metal, an alkaline earth metal, an alkali metal and an alloy.

10. An ion source as recited in claim 9, wherein the conductive material comprises a transition metal selected from the group consisting of iron, cobalt, nickel, copper, cadmium, silver, gold, platinum, lead, gallium, titantium, indium, magnesium, tin, vanadium and zinc

11. An ion source as recited in claim 7, wherein the ionization device is selected from the group consisting of electrospray ionization device, an atmospheric pressure photoionization device (APPI), a atmospheric chemical ionization device (APCI), a multimode ionization device, a chemical ionization device, a matrix assisted laser desorption ionization device (MALDI) and an atmospheric matrix assisted laser desorption ionization device (AP-MALDI).

12. An ion source as recited in claim 7, wherein the substrate is selected from the group consisting of a plate, a rotating drum and a rotating plate.

13. A method for producing ions, comprising:
(a) creating ions using an ionization device;
(b) storing the ions on a substrate; and
(c) releasing the stored ions from the substrate using a voltage source.

14. A method as recited in claim 13, wherein the ionization device is at atmospheric pressure.

15. A method for producing ions as recited in claim 13, wherein ionization device is above atmospheric pressure.

16. A method for producing ions as recited in claim 13, wherein the ionization device is above 100 mTorr.
